(19) United States
(12) Patent Application Publication
(10) Pub. No.: US 2012/0259709 A1
(43) Pub. Date: Oct. 11, 2012

(54) Systems and Methods for Associating Attribution Data with Digital Content

(75) Inventors: Sean Coates, Dorval (CA); Cameron Koczon, Brooklyn, NY (US)

(73) Assignee: GIMME BAR, INC., Brooklyn, NY (US)

(21) Appl. No.: 13/439,338

(22) Filed: Apr. 4, 2012

Related U.S. Application Data
(60) Provisional application No. 61/457,472, filed on Apr. 5, 2011.

(51) Int. Cl. G06Q 30/02

(52) U.S. Cl. 705/14.69

(57) ABSTRACT

System and method for providing context-independent compensation. Metadata is stored identifying a content source for original content. When the original content is displayed in a context that the content source does not control, compensation is nevertheless provided to the content source.

This application claims priority to U.S. provisional application 61/457,472, filed Apr. 5, 2011, incorporated herein by reference in its entirety.

### BACKGROUND

1. Field of the Invention

The present invention relates to systems and methods for associating attribution data with digital content. More particularly, aspects of the present invention relate to systems and methods for providing context-independent compensation to content creators and publishers.

2. Description of the Background

The widespread adoption of digital information networks (e.g., the Internet, the World Wide Web, etc.) and consumer electronic devices (e.g., personal desktop computers, smart phones, web tablets, ebook readers, etc.) provides content creators with an unprecedented ability to directly disseminate their works to audiences. For example, many content creators now publish to websites their text, images, audio, video, and interactive content (i.e., original content). Furthermore, many of these content creators also offer special-purpose computer applications (i.e., “Apps”) that enable audiences to view original content on selected electronic devices, such as smartphones and portable tablet computers. In addition, content publishing services have emerged that allow individuals to disseminate their respective original content to large audiences without requiring large publishing resources (e.g., the Flickr™ service provided by Yahoo!™ aids individuals in publishing original photographic content; the YouTube™ service provided by Google™ aids individuals in publishing video content, etc.).

Typically, original content that is disseminated using the above-described methods or services is presented to audiences in a context that is controlled by the content's creator or by a content publishing service chosen by the content's creator. For example, original content created by a news organization may be presented on that news organization's website in a context that includes additional data selected by the news organization, such as other semantically associated content (e.g., “Related Articles”), content from other content producers affiliated with that news organization, attribution information, and/or advertisement data. Such additional data presented in context with the original content is often part of a quid pro quo exchange between the audience and the content creator or content publisher (hereinafter referred to collectively as the “content source”): the audience views original content that they are interested in, while the content source receives context-dependent compensation, i.e., compensation that relies at least in part on the additional data that is included in the context presented by the content source. Context-dependent compensation includes, for example advertising revenue, reputational gains, and opportunities to upsell the audience on additional content, based on the additional data presented within the context.

As Internet users and other audiences identify interesting or notable original content, the users often take some action to enable themselves or others to more easily locate that original content for additional viewings, or to prepare the content data for viewing on a different electronic device. For example, an Internet user may download the content to his or her local storage medium (e.g., a magnetic disk drive or flash storage device), record the content on a remote storage device (e.g., a remote computer server or “cloud storage” system), the user may copy the content data onto another electronic device such as a cellular telephone or portable personal computer, the user may record the content data's Uniform Resource Locator (“URL”) as a browser bookmark or using another URL cataloging system, or the user may redistribute the content on the user's personal website, another website, or any other content distribution system.

In many instances, the users' actions may cause the original content to be viewed outside of the context provided by the content source. For example, a portion of the audience may view an image in the context of the user's personal website, rather than in the context of the content source's website. This can vitiate the quid pro quo between the the audience and the content source, as the content source does not receive any of the expected context-dependent compensation when the original content is displayed in a context not controlled by or affiliated with the content source.

What is desired are systems and methods for providing a content source with context-independent compensation, i.e., compensation that does not rely on the original content being displayed in a context that is controlled or affiliated with the content source.

### BRIEF SUMMARY

In one aspect, the present invention provides a method for providing context-independent compensation to a creator or publisher (i.e., a content source) of original content (e.g., text, images, audio, video, or interactive content) when the original content is displayed outside of the content source's intended context for the original content (e.g., when the original content is displayed outside of the content source's web page). In some embodiments, the method includes steps of: obtaining original content, wherein the original content includes data displayed in a source context by content source; obtaining metadata associated with the original content, wherein the metadata includes information identifying the content source; and displaying the original content in a non-source context context, wherein the step of displaying the original content in the non-source context includes providing context-independent compensation to the content source based on the the metadata.

In some embodiments, the context-independent compensation can include receiving advertising data (distinct from the original content) from the content source, and displaying the advertising data in the non-source context. In some embodiments, the context-independent compensation can include displaying other advertising data (e.g., advertising data that is not provided or selected by the content source) in the non-source context, and providing to the content source at least a portion of advertising revenue generated by the advertising data.

In one aspect, the present invention provides a system for providing context-independent compensation to a content source when original content is displayed outside of the content source's intended context for the original content. In some embodiments, the system includes a computer (e.g., a user terminal, a source computer, or an archive computer) configured to: store on a computer-readable medium original content, wherein the original content includes data displayed in a source context by content source; store on a computer-readable medium metadata associated with the original content, wherein the metadata includes information identifying the content source; and display the original content in a non-source context, wherein displaying the original content in the non-source context includes providing context-independent compensation to the content source based on the information identifying the content source stored in the metadata.

The above and other aspects of the present invention, as well as the structure and application of various embodiments of the present invention, are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

A more complete appreciation of the invention and the attendant advantages thereof will be readily obtained as the same becomes better understood by reference to the following detailed description when considered with the accompanying drawings wherein:

FIG. 1 is a block diagram of an exemplary system according to some aspects of the present invention.

FIG. 2 is a block diagram illustrating an exemplary user terminal according to some aspects of the present invention.

FIG. 3 is an exemplary user interface display according to some aspects of the present invention.

FIG. 4 is a flow chart illustrating a process for providing context-independent compensation according to some aspects of the present invention.

FIGS. 5A and 5B are exemplary user interface displays according to some aspects of the present invention.

FIG. 6 is a flow chart illustrating a process for determining the content source for original content according to some aspects of the present invention.

### DETAILED DESCRIPTION OF PREFERRED EMBODIMENTS

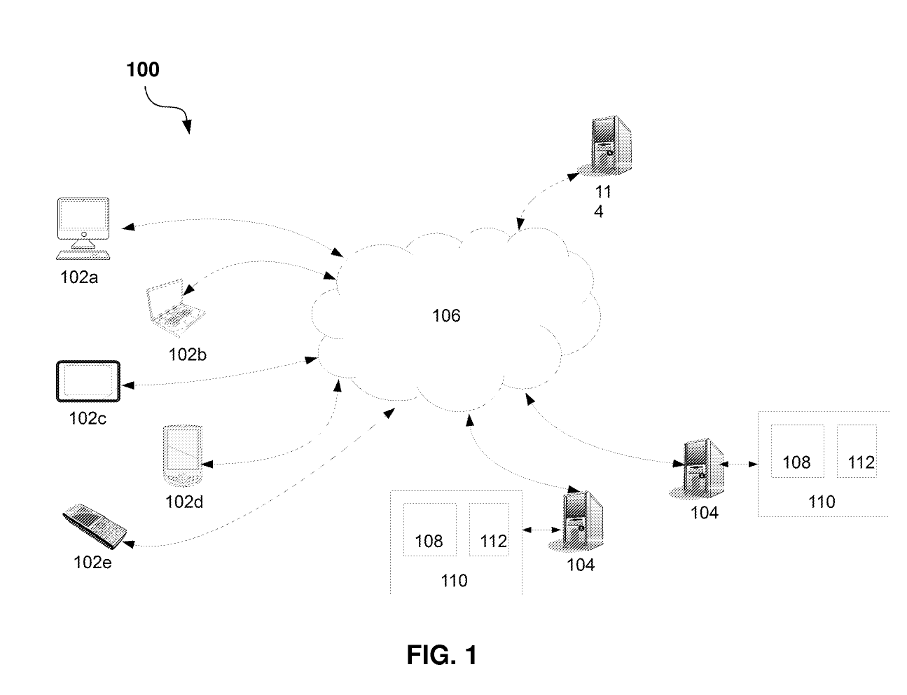

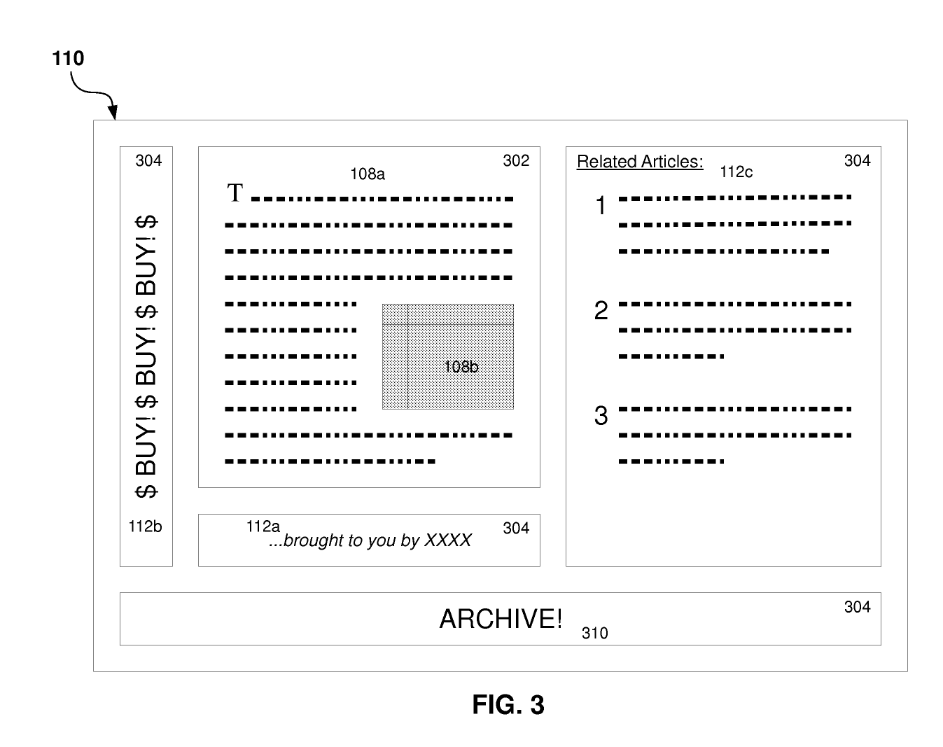

FIG. 1 is a block diagram of a system 100 according to some aspects of the present invention. As illustrated in FIG. 1, one or more user terminals 102 (e.g., one or more desktop computers 102a, laptop computers 102b, tablet computers 102c, personal digital assistants (“PDAs”) 102d, smart phones 102e, or any other device capable of displaying or otherwise delivering original content to a user) can access data (e.g., original content) stored on one or more source computers 104 (e.g., computers controlled by or affiliated with one or more content sources) via an electronic communication network 106 (e.g., the Internet, a cellular data network, etc.). For example, a source computer 104 can present original content 108 in a source context 110 (i.e., a context for displaying original content 108 that is controlled by or affiliated with the content source) such as a web site that includes additional data 112 (see FIG. 3).

In some embodiments of the present invention, the system 100 further includes an archive computer 114 that is coupled to the electronic communication network 106. The archive computer 114 can request original content 108 from the source computers 104, and can provide data or resources to the user terminals 102.

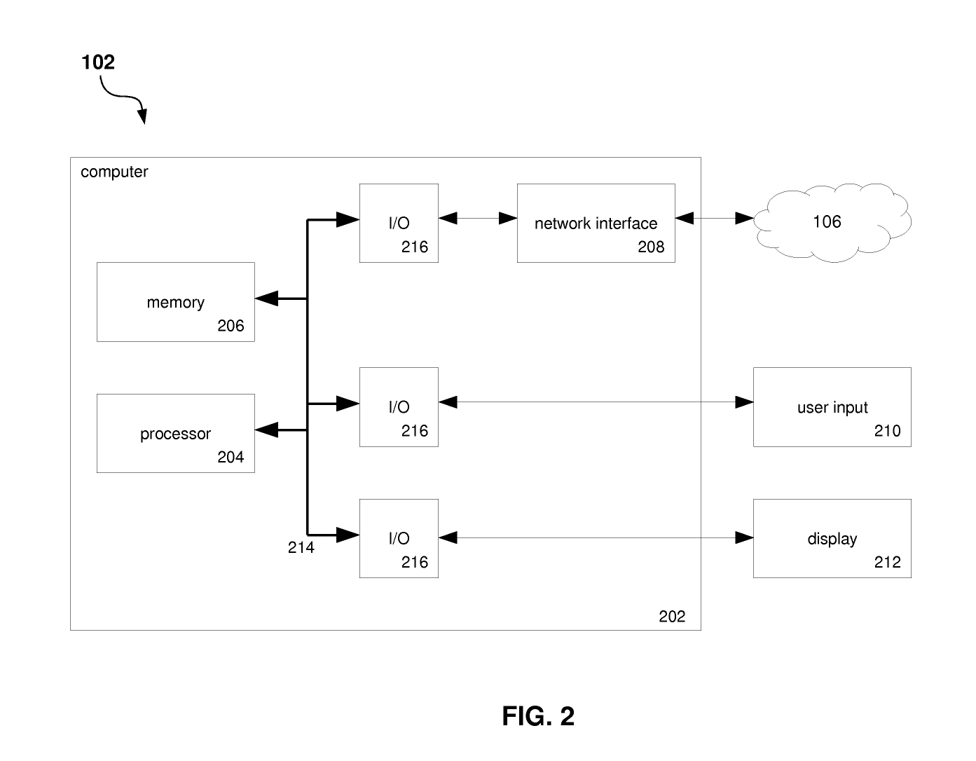

FIG. 2 is a block diagram illustrating a digital computer 202 (e.g., a user terminal 102, source computer 104, or archive computer 114) according to some aspects of the present invention. In some embodiments, the computer 202 contains one or more processors 204, an computer readable memory 206, a network interface 208, a user input interface 210, and a display 212. The processors 204 can include, for example, one or more of: an application specific integrated circuit (“ASIC”), field-programmable gate array (“FPGA”), a digital signal processor (“DSP”), an assembly of discrete logical elements (e.g., NAND gates, XOR gates, etc.), or a general purpose microprocessor configured to execute software instructions stored in a computer readable memory (e.g., software instructions stored in the computer readable memory 206). The computer readable memory 206 can include, for example, one or more of an electronic random access memory (“RAM”), an electronically erasable and programmable read only memory (“EEPROM”) such as a flash memory, a magnetic storage medium (e.g., a magnetic hard drive or tape drive), or any other computer readable medium or other means for storing computer executable instructions and/or data known to those having skill in the art. In some embodiments, information is transferred between the processor 204 and the computer readable memory 206 using an electronic data bus 214. The data bus 214 can also be connected to one or more input-output (“I/O”) units 216. In some embodiments, the I/O units 216 are coupled to the network interface 208, the user input interface 210, and the display 212. The network interface 208 (e.g., an Ethernet interface, a 802.11 wireless networking interface, cellular modem, etc.) may be coupled to the electronic communication network 106 for transmitting and receiving data. The user input interface 210 can include, for example, one or more input devices such as a keyboard, a mouse, a touchscreen, etc. The display 212 can include, for example, a cathode ray tube (“CRT”) display, a liquid crystal display (“LCD”), an organic light emitting diode (“OLED”) display, etc.

In some embodiments the user terminal 102, source computer 104, or archive computer 114 may omit one or more of the above components; alternatively or additionally, in some embodiments the user terminal 102, source computer 104, or archive computer 114 may include one or more additional elements. As will be understood by those having skill in the art, aspects of the present invention can be implemented using a broad array of commercially available computer hardware and software.

FIG. 3 illustrates a non-limiting example of a source context 110. In some embodiments, the source context 110 can be one or more pages of a website. The source context 110 can contain one or more display areas 302 for displaying original content 108 (e.g., text content 108a, image content 108b, or other types of content such as audio, video, or interactive content) and display areas 304 for displaying additional data 112. In some non-limiting examples, the additional data 112 can include attribution information 112a, advertisement data 112b, and supplemental or related content data 112c. In some embodiments, a source computer 104 can transmit (e.g., via the electronic communication network 106) to a user terminal 102 a source context 110 to be displayed on a display 212 of a user terminal 102.

FIG. 3 also illustrates an example of content archive interface 310. In some embodiments, the archive interface 310 enables a user to interact with the archive computer 114. For example, in some embodiments the user interacts with interface elements of the archive interface 310 to archive original content from the source context 110. In some exemplary embodiments, the archive interface 310 comprises one or more of: a bookmarklet, a web browser plug-in, a web browser extension, a web page, and a Hypertext Markup Language (“HTML”) file. In some embodiments, the archive interface 310 is displayed by a web browser or other computer software executing in whole or partially on the user terminal 102. In some embodiments, the archive interface 310 may be integrated with user interface controls of the web browser or other software, or displayed within the source context 110.

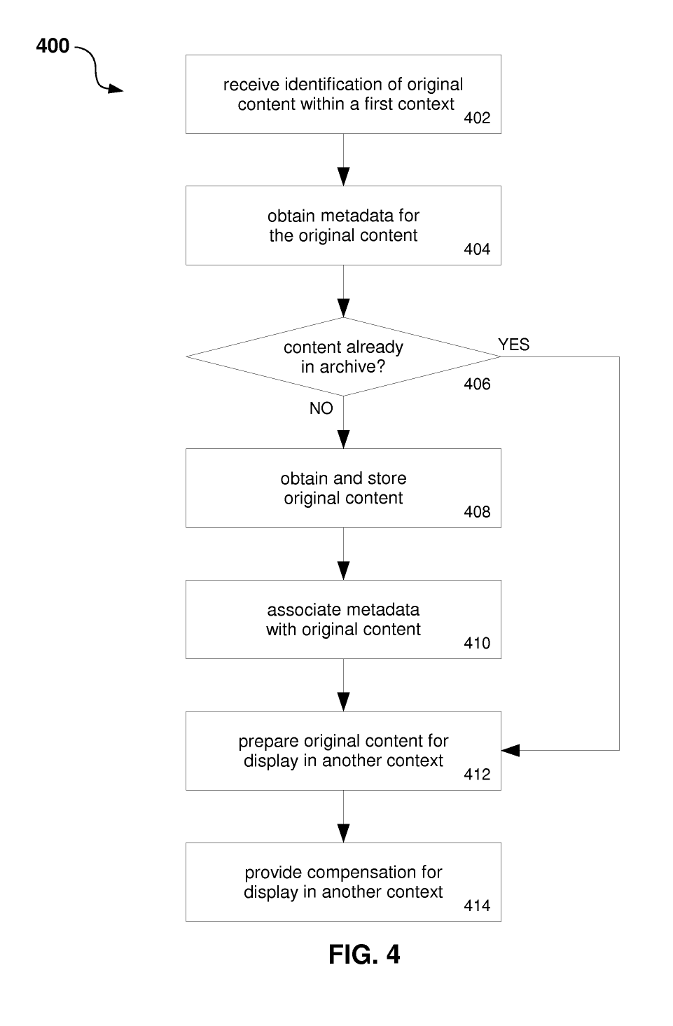

FIG. 4 is a flow chart illustrating a process 400 for providing context-independent compensation to a content source for original content when the original content is displayed in a context that is not controlled or affiliated with the content source according to some aspects of the present invention. In some embodiments, the process 400 is performed by a user terminal 102 executing software instructions (e.g., software instructions stored in the computer readable memory 206). In some embodiments, the process 400 is performed by a user terminal 102 executing instructions stored in a read only memory (“ROM”) or other firm ware. In one non-limiting example, all or part of the process 400 is performed by a user terminal 102 executing web browser software. In another non-limiting example, all or part of the process 400 is performed by the content source computer 104 or the archive computer 114.

The process 400 can begin at step 402 by receiving an identification of original content to extract from a context (e.g., a source context 110). In some embodiments, a user may provide a user input (e.g., a mouse click or touch screen tap) to identify the original content 108 from within the context (e.g., to identify a particular image or portion of text from a web page of the content source). In some embodiments, additional user input actions (e.g., interacting with additional user interface elements such as the archive interface 310) may be used to identify the original content within the context.

Alternatively or additionally, step 402 can be initiated without user input. In some exemplary embodiments, step 402 an be initiated whenever a user displays the context, and/or as part of an automated process (e.g., a “web crawler” or “web spider” process). In such embodiments, step 402 can identify the original content from the context using data processing heuristics understood by those having skill in the art to identify semantically relevant portions of the source context (e.g., identifying the text of an article and excluding advertisements within or around the article) or identify other portions of the context as original content.

The process 400 can continue at step 404 by obtaining metadata associated with the original content and storing the metadata on a computer-readable memory (e.g., a computer readable memory 206 of a user terminal 102 or an archive computer 114). In preferred embodiments, the metadata includes information identifying the content source of the original content. In the case where the original content is being displayed in the source context 110, the information identifying the content source may be determined from the source context 110. In an exemplary embodiment, if original content is being provided through a reference to an Internet resource via the content source's website, step 404 can include storing a URL for that resource. In some embodiments, step 404 can include obtaining other metadata from the source context (e.g., obtaining metadata from one or more HTML elements of the content source's website and/or source context 110). Alternatively or additionally, step 404 can include obtaining information from another source (e.g., obtaining data from a web browser or other software that is displaying the original content). In some embodiments, step 404 can include performing one or more analysis heuristics on the original content to generate the metadata. In some embodiments, the metadata is stored in the computer readable memory 206 of the user terminal 102. Alternatively or additionally, the metadata can be stored on a computer-readable medium of the archive computer 114.

In some embodiments, at step 406 the process 400 determine whether the original content 108 is already present in a content archive (e.g., whether the original content 108 is stored on a computer readable memory of the archive computer 114). In some embodiments, all or part of the content archive can be stored on the same computer-readable memory that was used in step 404 to store the metadata. Alternatively or additionally, all or part of the content archive can be stored on a separate computer readable memory.

In some embodiments, step 406 uses the metadata obtained in step 404 to determine whether the original content 108 is already present in the content archive. In an exemplary embodiment, step 406 can include determining whether the metadata obtained in step 404 matches metadata that is associated with content that is already in present in the content archive. In a case where the metadata for the original content matches metadata for content that is already present in the archive, the process 400 can proceed to step 412. In the case where the metadata for the original content does not match any metadata for content that is present in the content archive, the process 400 proceeds to step 408.

At step 408, the process 400 can include obtaining (e.g., via the electronic communication network 106) the original content 108 and storing the original content 108 in a content archive. In some embodiments, the original content 108 is stored in the computer readable memory 206 of the user terminal 102. Alternatively or additionally, the original content 108 can be stored on a computer-readable medium of the archive computer 114. In some embodiments, the original content 108 may be stored in a non-volatile computer-readable memory (e.g., a magnetic hard drive, an optical disc, flash memory, etc.). In some embodiments, the original content 108 can be stored in a volatile computer-readable memory (e.g., static random access memory (“SRAM”), dynamic random access memory (“DRAM”), etc.). In some embodiments, the original content can be stored on the same computer-readable medium that was used in step 404 to store the metadata. Alternatively or additionally, the metadata can be stored on a separate computer readable medium.

At step 410, the metadata is associated with the original content 108. In some exemplary embodiments, the metadata and the original content 108 can be associated in a database, a look-up table, or other information storage system. Other techniques for associating and storing the original content and the metadata will be readily understood by those having skill in the art.

At step 412, the process 400 prepares the original content 108 for display in a non-source context (i.e., a context that is not controlled by or affiliated with the content source). In some embodiments, step 412 may be performed by the archive computer 114 or user terminal 102 including the original content 108 in the context of a second website (i.e., including the original content 108 in a website different from the content source's website). Alternatively or additionally, step 412 may be performed by the archive computer 114 or user terminal 102 including the original content in the context of another application (i.e., including the original content for display in an application other than a web browser).

In some embodiments, step 412 includes the archive computer 114 or another computer transmitting (e.g., via the electronic communication network 106) the original content 108 to the user terminal 102 for display at the user terminal 102 (e.g., using a display 212 of the user terminal 102) in a non-source context.

In some preferred embodiments, step 412 occurs in response to a user input (e.g., a mouse click or tap of a touch screen) to identify the original content for display. In some embodiments, additional user input actions (e.g., interacting with additional user interface elements) may be used to identify the original content. In an exemplary embodiment, step 412 occurs in response to a user selecting the original content 108 from a user interface (e.g., a website) for accessing the content of one or more archive computers 114.

In some preferred embodiments, the source context 110 may be configured for a first viewport having expected dimensions, while step 412 prepares the original content 108 for display in a non-source context configured for a second viewport having different expected dimensions. In one non-limiting example, the source context 110 may be configured for a desktop display having a VGA viewport (i.e., 640×480 pixels), while step 412 prepares the original content 108 for display in a non-source context configured for a mobile device having a smaller screen resolution, such as a smartphone having a QVGA viewport (i.e., 320×240 pixels). Thus the step 412 can include altering the resolution and/or dimensions of image or video content, performing layout and/or text flow changes for text content, etc.

In some preferred embodiments, the source context 110 may be configured for a first set of human computer interaction (“HCI”) capabilities, while step 412 prepares the original content for display in a non-source context configured for a second set of HCI capabilities. In one non-limiting example, the source context 110 may be configured for display on a desktop computer 102a handling HCI events such as keyboard input and mouse clicks, while step 412 prepares the original content for display in a non-source context configured for display on a smartphone 102e handling different HCI events such as touch events or verbal commands. Thus step 412 can include, for example, altering the effects and/or types of user input actions for interactive content.

At step 414, the process 400 provides context-independent compensation to the content source (e.g., the creator or publisher of the original content 108). In some embodiments, step 414 can include identifying the content source for the original content based on the metadata obtained at step 404 and associated with the original content at step 408. The context-independent compensation can supplement or replace the context-dependent compensation that the content source would have received for displaying the original content in the source context 110.

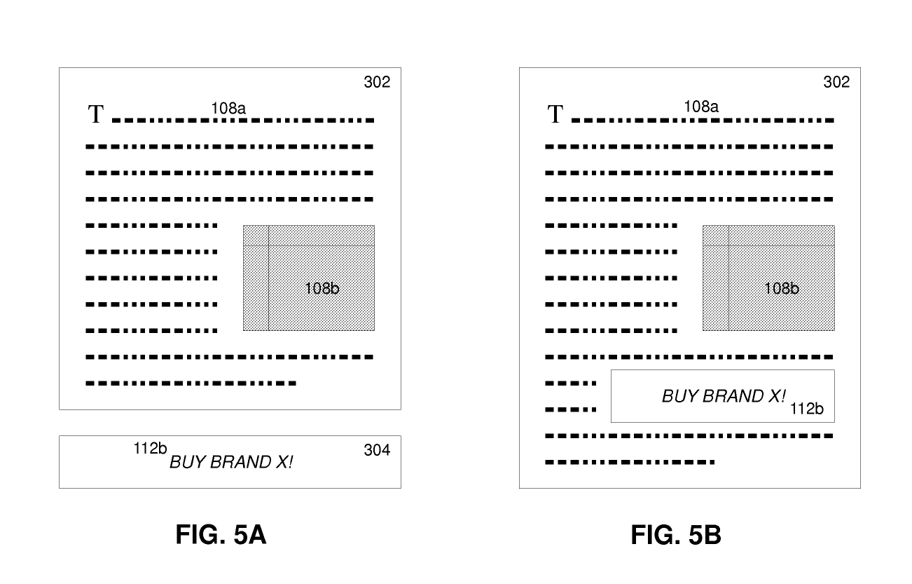

In a non-limiting example, providing context-independent compensation to the content source can include displaying advertising data 112b in the non-source context, e.g., in a separate display area 304 (see FIG. 5A) or overlayed on top of the original display area 302 (see FIG. 5B).

In some embodiments, the advertising data 112b can include advertising data that may be chosen by or otherwise identified by the content source, such as banner ads promoting the content source's products or services, thereby providing the content source with opportunities to upsell the audience on additional content (e.g., similar to opportunities that would have been available if the original content 108 were displayed in the source context 110).

In some embodiments, the advertising data 112b can include advertising data that is not chosen by or otherwise identified by the content source. In these embodiments, the content source may simply be apportioned a share of the advertising revenue generated by displaying the advertising data 112b with the original content 108 in the non-source context.

In an exemplary embodiment, the content source may determine the form of content-independent compensation that is appropriate for displaying the original content 108 in a non-source context (e.g., by preparing an a priori licensing agreement with one or more third parties that may wish to display the source content 108 in a non-source context). In another exemplary embodiment, the form of context-independent compensation may be chosen by a third party that wishes to display the original content 108 in a non-source context; in this embodiment, the third party may provide the context independent compensation to the content source without any prior arrangement.

Thus, according to some aspects of the process 400, a content source (e.g., a creator or publisher of original content) can receive context-independent compensation for the display of original content. That is, the content source can receive compensation for the display of original content, regardless of whether the original content is displayed in the source context 110 or another context that is not controlled by the content source.

It may occur that the content source of original content is not immediately apparent from the context in which the original content is being displayed. As described above, original content from a content source may be copied and displayed in a context different than the source context 110. In these circumstances, step 404 of the process 400 (i.e., obtaining the metadata that identifies the content source) may require a determination of the content source apart from merely identifying the current context of the original content.

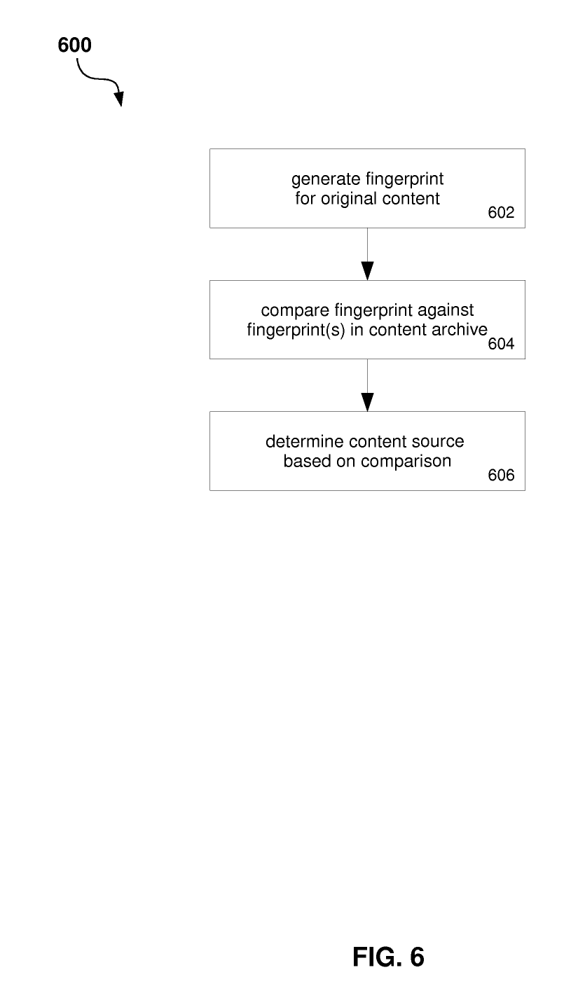

FIG. 6 is a flow chart illustrating a process 600 for determining the content source for original content (e.g., original content 108) according to some aspects of the present invention. In some embodiments, the process 600 is performed by a user terminal 102 executing software instructions (e.g., software instructions stored in the computer readable memory 206). In some embodiments, the process 600 is performed by a user terminal 102 executing instructions stored in a read only memory (“ROM”) or other firm ware. In one non-limiting example, all or part of the process 600 is performed by a user terminal 102 executing web browser software. In another non-limiting example, all or part of the process 600 is performed by the archive computer 114. In some preferred embodiments, the process 600 is performed in concert with the process 400.

The process 600 can begin at step 602 by generating a fingerprint for the original content 108. In some embodiments, the fingerprint can include the result of applying to the original content a cryptographic hash function (e.g., MD5, SHA, etc.) or any other suitable fingerprint algorithm understood by those having skill in the art. In some embodiments, the fingerprint can include at least a portion of the original content. Alternatively or additionally, the fingerprint can include the result of applying a cryptographic hash function (or any other suitable fingerprint algorithm understood by those having skill in the art) to metadata (e.g., the metadata obtained in step 404 of the process 400) associated with the original content. In some embodiments, the fingerprint can include at least a portion of the metadata. In an exemplary embodiment, the fingerprint can comprise the result of applying the MD5 algorithm to an HTML <embed> or <object> tag associated with the original content, or other metadata that can be used to uniquely identify the original content.

In some embodiments, the step 602 can occur contemporaneously with one or more of the steps in the process 400 (e.g., step 602 can occur contemporaneously with step 404 of the process 400). Furthermore, step 404 as described above with reference to the process 400 can also include storing the fingerprint in association with the metadata.

At step 604, the process 600 compares the fingerprint for the original content with a corpus of fingerprints corresponding to instances of original content with known content sources. In one non-limiting example, the corpus of fingerprints may include fingerprints that were previously generated (e.g., generated according to step 602) for other original content and that have been previously stored (e.g., stored on the archive computer 114) with metadata that identifies a content source according to the process 400 described above.

Furthermore, in some embodiments step 406, described above with reference to the process 400, can further comprise comparing the fingerprint of the original content against similarly generated fingerprints for content already present in the archive.

In another exemplary embodiment, the corpus of fingerprints may include fingerprints that are provided by one or more potential content sources (i.e., one or more content creators and publishers) and that correspond to the potential content sources' respective original content (e.g., The New York Times or Washington Post may provide fingerprints for each of their respective articles, Flickr may provide fingerprints for each Flickr-hosted image, etc.).

In another non-limiting example, all or part of the comparison may be performed by one or more content sources. In this example, the step 604 can include providing the fingerprint for the original content 108 to a potential content source and receiving information from the potential content source indicating whether that content source is the source of the original content 108. In some embodiments, the fingerprint for the original content 108 can be provided to one or more potential content sources based on characteristics of the original content 108 (e.g., fingerprints for image data may be provided to potential content sources associated with image content, fingerprints for video data may be provided to potential content sources associated with video content, etc.).

Based on the result of the comparison from step 604, the content source of the original content is identified at step 606. In a case where the fingerprint for the original content 108 matches a fingerprint generated for content that has been previously stored with metadata that identifies a content source, the content source of the original content 108 is determined to be the content source of the other content that was previously stored. In a case where the fingerprint of the original content matches a fingerprint in a corpus of fingerprints provided by a potential content source, the content source for the original content 108 is determined to be that potential content source.

Alternatively or additionally, in some embodiments, determining the content source for original content can include detecting the presence of one or more perceptible or imperceptible digital watermarks or other information within the original content (e.g., a logo or trademark identifying the content source, steganographic information, etc.) according to techniques that will be readily understood by those having skill in the art.

While various embodiments of the present invention have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless indicated herein or otherwise clearly contradicted by context.

What is claimed is:

1. A method for providing context-independent compensation to a content source of original content, comprising:
(a) receiving a user input identifying said original content in a first context;
(b) storing on a computer-readable medium said original content;
(c) storing on a computer-readable medium metadata associated with said original content, wherein said metadata includes information identifying said content source;
(d) transmitting said original content for display in a second context; and
(e) providing context-independent compensation to said content source based on said metadata.

2. The method of claim 1, wherein providing said context-independent compensation comprises:
(i) receiving advertising data from said content source; and
(ii) transmitting said advertising data for display in said second context.

3. The method of claim 1, wherein providing said context-independent compensation comprises:
(i) transmitting advertising data for display in said second context; and
(ii) allocating for said content source a portion of advertising revenue paid in connection with display of said advertising data in said second context.

4. The method of claim 1, wherein said user input comprises a user input to an archive interface displayed in said first context.

5. The method of claim 1, wherein step (d) occurs in response to a user input requesting said original content be displayed in said second context.

6. The method of claim 1, wherein said first context is configured for display in a first viewport, and said second context is configured for display in a second viewport, wherein said first and second viewports are not identical.

7. The method of claim 1, wherein said first context is configured for a first set of human computer interaction capabilities, and said second context is configured for a second set of human computer interaction capabilities, wherein said first and second sets of human computer interaction capabilities are not identical.

8. The method of claim 1, wherein said first context comprises a context controlled by or affiliated with said content source.

9. The method of claim 1, wherein step (c) comprises:
(i) determining that an attribute of said original content corresponds to an attribute of a content instance stored in a content archive,
(ii) obtaining archive metadata from said content archive, wherein said archive metadata includes information identifying a source of said content instance,
(iii) storing on a computer-readable medium said archive metadata, and
(iv) associating said archive metadata with said original content.

10. The method of claim 9, wherein determining that an attribute of said original content corresponds to an attribute of said content instance comprises:
(1) obtaining a digital fingerprint for said original content;
(2) obtaining a digital fingerprint for said content instance; and
(3) comparing said digital fingerprint for said original content with said digital fingerprint for said content instance.

11. The method of claim 10, wherein obtaining a digital fingerprint for said content instance comprises receiving said digital fingerprint from said content source.

12. The method of claim 9, wherein determining that an attribute of said original content corresponds to an attribute of said content instance comprises:
(1) providing one or more attributes of said original content to said content source, and
(2) receiving information from said content source indicating that one or more attributes of said original content correspond to content stored on a content archive of said content source.

13. The method of claim 9, wherein step (i) further comprises:
(1) identifying one or more potential content sources based upon one or more attributes of said original content; and
(2) for each of said potential content sources, determining whether one or more attributes of said original content correspond to one or more attributes of content instances stored in a content archive associated with that potential content source.

14. The method of claim 9, wherein said original content attribute is a value extracted from a watermark embedded in said original content.

15. A system for providing context-independent compensation to a content source of original content, comprising:
one or more computers configured to:
(a) receive a user input identifying said original content in a first context;
(b) store on a computer-readable medium said original content;
(c) store on a computer-readable medium metadata associated with said original content, wherein said metadata includes information identifying said content source;
(d) transmit said original content for display in a second context; and
(e) provide context-independent compensation to said content source based on said metadata.
